(19) United States
(12) Patent Application Publication
(10) Pub. No.: US 2022/0062667 A1
(43) Pub. Date: Mar. 3, 2022

(54) Oxygen Mask And System

(71) Applicant: B/E Aerospace, Inc., Winston-Salem, NC (US)

(72) Inventor: John T. Barker, Overland Park, KS (US)

(21) Appl. No.: 17/006,069

(22) Filed: Aug. 28, 2020

(51) Int. Cl. A62B 7/14; A62B 7/00; A62B 9/02; A62B 18/02

(52) U.S. Cl. CPC A62B 7/14; A62B 18/025; A62B 9/02; A62B 7/00

(57) ABSTRACT

A system may include an oxygen mask. The oxygen mask may include an oxygen supply structure. The oxygen mask may include a face seal extending away from the oxygen supply structure, wherein the face seal forms an outer opening configured to seal around a first portion of a first face of a first user of the oxygen mask, wherein a channel is formed by the face seal between the outer opening and the oxygen supply structure. The oxygen mask may include a lip seal positioned within the channel and positioned between the outer opening and the oxygen supply structure, wherein the lip seal forms a second opening configured to seal around a second portion of a second face of a second user of the oxygen mask, wherein the second opening is smaller than the outer opening, wherein the second face is smaller than the first face.

### BACKGROUND

Existing certified passenger oxygen masks utilized for pulse type supplemental and first-aid oxygen systems are designed to fit adults rather than infants and children. Existing certified pulse oxygen masks may be too large for infants and small children. In a civilian aviation environment, currently no oxygen mask accommodation regulation is made specifically for infants and children below the age of five.

### SUMMARY

In one aspect, embodiments of the inventive concepts disclosed herein are directed to a system. The system may include an oxygen mask. The oxygen mask may include an oxygen supply structure. The oxygen mask may include a face seal extending away from the oxygen supply structure, wherein the face seal forms an outer opening configured to seal around a first portion of a first face of a first user of the oxygen mask, wherein a channel is formed by the face seal between the outer opening and the oxygen supply structure. The oxygen mask may include a lip seal positioned within the channel and positioned between the outer opening and the oxygen supply structure, wherein the lip seal forms a second opening configured to seal around a second portion of a second face of a second user of the oxygen mask, wherein the second opening is smaller than the outer opening, wherein the second face is smaller than the first face.

In a further aspect, embodiments of the inventive concepts disclosed herein are directed to an oxygen mask. The oxygen mask may include an oxygen supply structure. The oxygen mask may include a face seal extending away from the oxygen supply structure, wherein the face seal forms an outer opening configured to seal around a first portion of a first face of a first user of the oxygen mask, wherein a channel is formed by the face seal between the outer opening and the oxygen supply structure. The oxygen mask may include a lip seal positioned within the channel and positioned between the outer opening and the oxygen supply structure, wherein the lip seal forms a second opening configured to seal around a second portion of a second face of a second user of the oxygen mask, wherein the second opening is smaller than the outer opening, wherein the second face is smaller than the first face.

### BRIEF DESCRIPTION OF THE DRAWINGS

Implementations of the inventive concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 a cross-sectional view of an exemplary embodiment of a system including a vehicle including an oxygen mask according to the inventive concepts disclosed herein.

FIG. 2 is a cross-sectional view of an exemplary embodiment of the oxygen mask of FIG. 1 according to the inventive concepts disclosed herein.

FIG. 3 is an isometric view of an exemplary embodiment of the oxygen mask of FIG. 1 according to the inventive concepts disclosed herein.

FIG. 4 is an isometric view of an exemplary embodiment of the oxygen mask of FIG. 1 according to the inventive concepts disclosed herein.

FIG. 5 is a front view of an exemplary embodiment of the oxygen mask of FIG. 1 according to the inventive concepts disclosed herein.

FIG. 6 is a side view of an exemplary embodiment of the oxygen mask of FIG. 1 according to the inventive concepts disclosed herein.

FIG. 7 is a view of an exemplary embodiment of the oxygen mask of FIG. 1 according to the inventive concepts disclosed herein.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to a system including an oxygen mask. Some embodiments may include a supplemental and/or first-aid type of oxygen mask. Some embodiments may improve air travel safety by providing an oxygen mask that can accommodate adults and children (e.g., children and/or infants).

In some embodiments, the oxygen mask may include sealing portions (e.g., a face seal and a lip seal) and an inhalation and exhalation valve suitable for use in pulse oxygen systems. The sealing portions may not significantly affect installation, deployment, or use of the oxygen system as currently certified for pulse oxygen systems, continuous flow oxygen systems, and first aid oxygen systems. For example, the lip seal may be designed to maintain a vacuum in a mask cavity during inhalation no less than that of a cracking pressure of the inhalation valve of the mask while ensuring that the system is able to sense a breath and thus deliver a pulse of oxygen. The lip seal can support a typical adult without undue discomfort or compromise of system effectiveness, and therefore, can facilitate wide scale use. In some embodiments, the oxygen mask may be used as a first aid oxygen mask and systems. In some embodiments, the oxygen mask may be a continuous flow oxygen mask.

In some embodiments, a pulse oxygen system may deliver oxygen on-demand. When the user inhales, the system may sense a breath by measuring or sensing against vacuum conditions that result inside the mask cavity. The system may respond to inhalation by delivering a precisely metered volume (i.e., a pulse) of oxygen to the mask. As the effectiveness and efficiency of the pulse system can depend on delivering the pulse of oxygen early in the inhalation cycle, the mask can help ensure that the inhalation is detected in a reliable and timely manner.

Existing certified pulse oxygen masks and continuous flow oxygen masks account for a certain amount of inward leakage into the mask for certain individuals; however, if the existing mask is found to be too large for an individual (e.g., too large for an infant or young child) to establish an effective seal between the mask and face, this could compromise the system such that a pulse is not delivered or the timing of such delivery may not be of an expected benefit. In some embodiments, the oxygen mask may include unique sealing portions while retaining the inhalation and exhalation valve design of existing masks. In some embodiments, the oxygen mask may have a size, shape, and function such that the mask does not significantly affect the installation, deployment, or use of the oxygen system as currently certified.

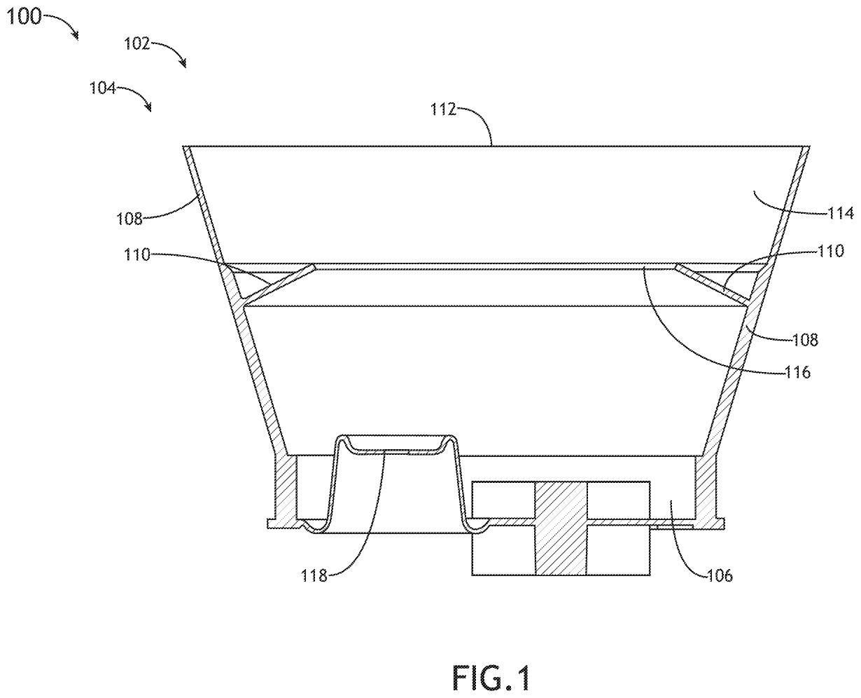

Referring now to FIG. 1, a cross-sectional view of an exemplary embodiment of a system 100 including a vehicle (e.g., aircraft 102, watercraft, automobile, train, etc.) including at least one oxygen mask 104 (e.g., a pulse oxygen mask or a continuous flow oxygen mask) is depicted according to the inventive concepts. In some embodiments, the oxygen mask 104 may include an oxygen supply structure 106, a face seal 108, and/or a lip seal 110. The oxygen mask 104 may be configured to accommodate a user of any age (e.g., adults and children of all ages) and any size.

The oxygen supply structure 106 may include at least one valve 118 (e.g., an inhalation and exhalation valve). In some embodiments, the oxygen supply structure 106 may be rigid, semi rigid or flexible.

The face seal 108 may extend away from the oxygen supply structure 106. The face seal 108 may form an outer opening 112 configured to seal around a first portion of a first face of a first user of the oxygen mask 104. A channel 114 may be formed by the face seal 108 between the outer opening 112 and the oxygen supply structure 106. The face seal 108 may be shaped as a first portion of a first cone surface; however, in some embodiments, the face seal 108 may have any suitable shape. In some embodiments, the outer opening 112 may be circular with a diameter of between 3 inches and 4 inches (between 7.62 centimeter (cm) and 10.16 cm); however, in some embodiments, the outer opening 112 may have any suitable shape. In some embodiments, the face seal 108 may be formed of at least one conformable flexible material (e.g., at least one thermoplastic elastomer, latex, and/or silicone).

The lip seal 110 may be positioned within the channel 114 and positioned between the outer opening 112 and the oxygen supply structure 106. The lip seal 110 may form a second opening 116 configured to seal around a second portion of a second face of a second user of the oxygen mask 104. The second opening 116 may be smaller than the outer opening 112, and the second face may be smaller than the first face. The lip seal 110 may be shaped as a second portion of a second cone surface; however, in some embodiments, the lip seal 110 may have any suitable shape. In some embodiments, the lip seal 110 may extend away from the face seal 108 at an angle between 70 and 110 degrees. In some embodiments, the second opening 116 may be circular with a diameter of between 1.5 inches and 2.5 inches (between 3.81 cm and 6.35 cm); however, in some embodiments, the second opening 116 may have any suitable shape. For example, the lip seal 110 may be conformable and flexible and positioned so as to define the second opening 116 appropriate for use by an infant and or child. In some embodiments, the second opening 116 may be of a size that if necessary, can support the breathing of a typical adult without undue discomfort or compromise of system effectiveness and therefore facilitate wide scale use with both pulse and constant flow oxygen systems. In some embodiments, the lip seal 110 may have mechanical and section characteristics so as to form a seal between the user and the oxygen mask 104. The lip seal 110 may be designed to ensure a vacuum can be maintained in the mask cavity during inhalation that is no less than the cracking pressure of the inhalation valve of the mask. In some embodiments, the lip seal 110 may be formed of at least one conformable flexible material (e.g., at least one thermoplastic elastomer, latex, and/or silicone). In some embodiments, the lip seal 110 and the face seal 108 may be formed of a same or similar material.

In some embodiments, the face seal 108 and the lip seal 110 are formed of an integral material. In some embodiments, the face seal 108 and the lip seal 110 may be separate components, wherein the lip seal 110 may abut an interior surface of the face seal 108. For example, the lip seal 110 may be an insert that is inserted into an existing certified oxygen mask.

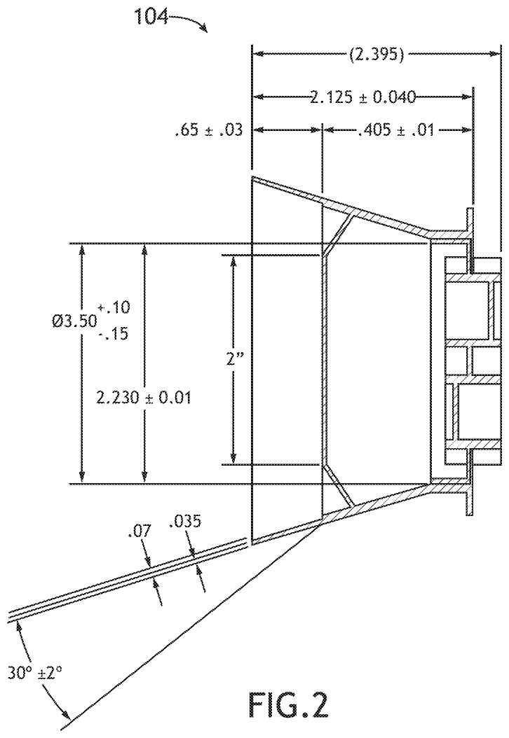

Referring now to FIG. 2, a cross-sectional view of an exemplary embodiment of the oxygen mask 104 of FIG. 1 is depicted according to the inventive concepts. FIG. 2 depicts exemplary suitable dimensions (e.g., in inches) and angular orientations (e.g., in degrees) of various components of the oxygen mask 104.

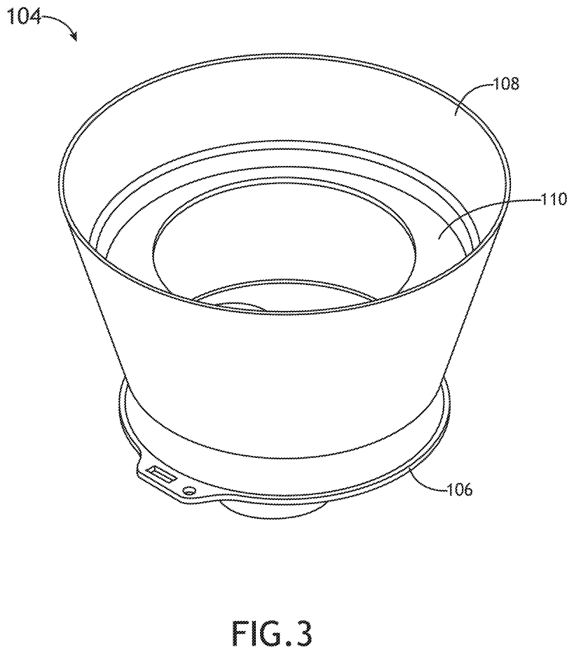

Referring now to FIG. 3, an isometric view of an exemplary embodiment of the oxygen mask 104 of FIG. 1 is depicted according to the inventive concepts.

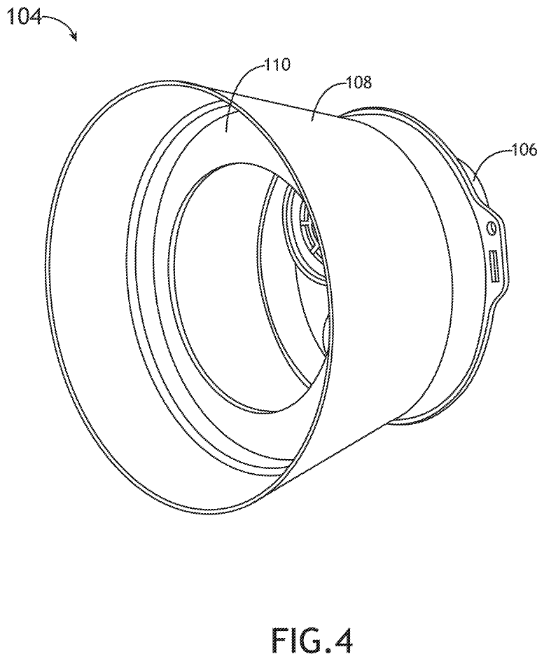

Referring now to FIG. 4, an isometric view of an exemplary embodiment of the oxygen mask 104 of FIG. 1 is depicted according to the inventive concepts.

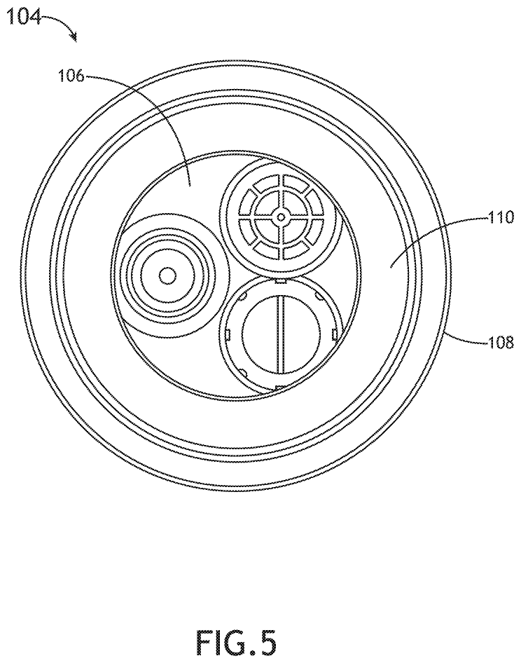

Referring now to FIG. 5, a front view of an exemplary embodiment of the oxygen mask 104 of FIG. 1 is depicted according to the inventive concepts.

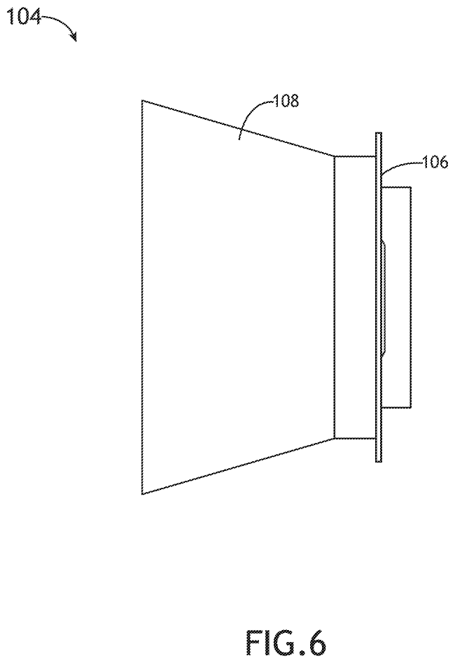

Referring now to FIG. 6, a side view of an exemplary embodiment of the oxygen mask 104 of FIG. 1 is depicted according to the inventive concepts.

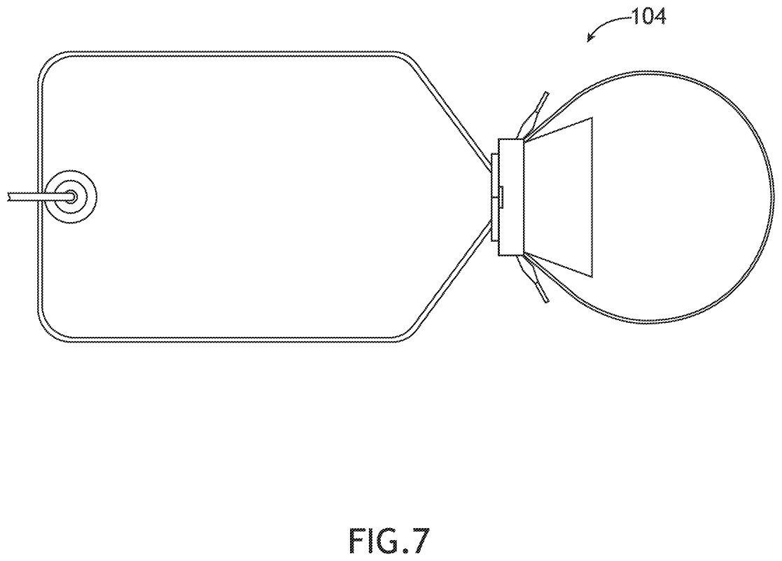

Referring now to FIG. 7, a view of an exemplary embodiment of the oxygen mask 104 of FIG. 1 is depicted according to the inventive concepts. As shown in FIG. 7, the oxygen mask 104 may be a continuous flow oxygen mask.

As will be appreciated from the above, embodiments of the inventive concepts disclosed herein may be directed to a system including an oxygen mask.

As used throughout, “at least one” means one or a plurality of; for example, “at least one” may comprise one, two, three, . . . , one hundred, or more. Similarly, as used throughout, “one or more” means one or a plurality of; for example, “one or more” may comprise one, two, three, . . . , one hundred, or more. Further, as used throughout, “zero or more” means zero, one, or a plurality of; for example, “zero or more” may comprise zero, one, two, three, . . . , one hundred, or more.

In the present disclosure, the methods, operations, and/or functionality disclosed may be implemented as sets of instructions or software readable by a device. Further, it is understood that the specific order or hierarchy of steps in the methods, operations, and/or functionality disclosed are examples of exemplary approaches. Based upon design preferences, it is understood that the specific order or hierarchy of steps in the methods, operations, and/or functionality can be rearranged while remaining within the scope of the inventive concepts disclosed herein. The accompanying claims may present elements of the various steps in a sample order, and are not necessarily meant to be limited to the specific order or hierarchy presented.

It is to be understood that embodiments of the methods according to the inventive concepts disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. A system, comprising:
an oxygen mask, comprising:
an oxygen supply structure;
a face seal extending away from the oxygen supply structure, wherein the face seal forms an outer opening configured to seal around a first portion of a first face of a first user of the oxygen mask, wherein a channel is formed by the face seal between the outer opening and the oxygen supply structure; and
a lip seal positioned within the channel and positioned between the outer opening and the oxygen supply structure, wherein the lip seal forms a second opening configured to seal around a second portion of a second face of a second user of the oxygen mask, wherein the second opening is smaller than the outer opening, wherein the second face is smaller than the first face.

2. The system of claim 1, wherein the face seal is shaped as a first portion of a first cone surface, wherein the lip seal is shaped as a second portion of a second cone surface.

3. The system of claim 2, wherein the lip seal extends away from the face seal at an angle between 70 and 110 degrees.

4. The system of claim 3, wherein the second opening has a diameter of between 1.5 inches and 2.5 inches, wherein the outer opening has a diameter of between 3 inches and 4 inches.

5. The system of claim 4, wherein the face seal and the lip seal are formed of a thermoplastic elastomer.

6. The system of claim 5, wherein the oxygen mask is configured to accommodate a user of any age.

7. The system of claim 1, wherein the face seal and the lip seal are formed of at least one conformable flexible material.

8. The system of claim 1, wherein the face seal and the lip seal are formed of a thermoplastic elastomer.

9. The system of claim 1, wherein the face seal and the lip seal are formed of an integral material.

10. The system of claim 1, wherein the face seal and the lip seal are separate components, wherein the lip seal abuts an interior surface of the face seal.

11. The system of claim 1, wherein the oxygen mask is a pulse oxygen mask.

12. The system of claim 11, wherein the oxygen supply structure includes a valve.

13. The system of claim 1, wherein the oxygen mask is a continuous flow oxygen mask.

14. The system of claim 1, further comprising an aircraft, the aircraft comprising the oxygen mask.

15. An oxygen mask, comprising
an oxygen supply structure;
a face seal extending away from the oxygen supply structure, wherein the face seal forms an outer opening configured to seal around a first portion of a first face of a first user of the oxygen mask, wherein a channel is formed by the face seal between the outer opening and the oxygen supply structure; and
a lip seal positioned within the channel and positioned between the outer opening and the oxygen supply structure, wherein the lip seal forms a second opening configured to seal around a second portion of a second face of a second user of the oxygen mask, wherein the second opening is smaller than the outer opening, wherein the second face is smaller than the first face.
